(19) United States
(12) Patent Application Publication
(10) Pub. No.: US 2007/0030479 A1
(43) Pub. Date: Feb. 8, 2007

(54) METHOD OF INSPECTING A DEFECT ON A SUBSTRATE

(75) Inventors: Sung-Hong PARK, Seoul (KR); Young-Jee YOON, Gyeonggi-do (KR); Jung-Taek LIM, Gyeonggi-do (KR); Chung-Sam JUN, Gyeonggi-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/462,954

(22) Filed: Aug. 7, 2006

(30) Foreign Application Priority Data
Aug. 6, 2005 (KR) 2005-71984

(51) Int. Cl. G01N 21/88

(52) U.S. Cl. 356/237.2

(57) ABSTRACT

In a method, with improved utilization of memory, of inspecting a defect on an object, the object is divided into a plurality of inspection regions. A plurality of levels is determined according to the numbers of defects, which are expected before detecting the defects, on the inspection regions. The defects on a selected inspection region are detected. The level including a range, which corresponds to the number of defects detected on the selected inspection region, is assigned to the selected inspection region with reference to the number of defects detected on the selected inspection region. The steps of detecting defects and assigning levels are repeated with respect to remaining inspection regions.

### CROSS-REFERENCE TO RELATED APPLICATION

This application claims benefit of priority under 35 U.S.C. § 119 from Korean Patent Application No. 2005-71984 filed on Aug. 6, 2005, the disclosure of which is incorporated herein by reference in its entirety.

### BACKGROUND

1. Field of the Invention

The present invention relates to methods of inspecting a defect on a substrate. More particularly, the present invention relates to methods of inspecting a defect, such as a particle, on a substrate utilized for manufacturing a semiconductor device.

2. Description of the Related Art

Semiconductor devices are generally manufactured through a fabrication (FAB) process of forming integrated circuits on a substrate, an electrical die sorting (EDS) process for inspecting electrical characteristics of the integrated circuits, and a packaging process for separating individual semiconductor devices.

The FAB process may further include a deposition process for forming a layer on the substrate, a polishing process for planarizing the layer positioned on the substrate, a photo process for forming a photoresist pattern on the layer, an etching process for etching the layer to form electrical patterns on the substrate, an ion implantation process for forming a impurity region in the substrate, a cleaning process for removing particles from the substrate, and an inspecting process for detecting defects of the substrate, the layer, the patterns, etc.

While the above processes are performed, precise control of process conditions, such as pressure and temperature, is necessary to improve quality and yield of the semiconductor device.

In order to achieve a high degree of integration, it is necessary to detect defects (e.g., particles) on a substrate used to manufacture the semiconductor device. This is because the defects may deteriorate the operation of the semiconductor device.

The defects may be inspected using an inspecting device. Information regarding the types and positions of the defects may be stored in memory. Here, if the stored information about the defects exceeds the storage limit of the inspecting device, the operation of the inspecting device may stop. That is, the process of inspecting substrate defects may be interrupted.

To overcome the above problem, the following methods are used.

According to a first conventional method, defects within a certain area or volume on a substrate are regarded as one defect. For example, the defects within a certain area on the substrate may be regarded as one defect regardless of the number of defects within that area. Thus, it is difficult to precisely calculate the actual number of defects on the substrate.

According to a second conventional method, the resolution of the detecting device is reduced so that the number of defects detected is dependent on defect size. For example, only some defects having relatively large sizes are detected. On the other hand, remaining defects having relatively small sizes are not detected. In this case, the remaining defects are not considered.

According to a third conventional method, defects on a substrate are detected and their information is stored in memory. If the memory capacity is exceeded, an inspection process may be stopped, which causes any remaining defects to not be inspected. In this case, when the number of defects on the entire substrate is relatively small, all of the defects on the substrate may be detected. However, when the number of defects on the entire substrate is relatively large, all of the defects on the substrate may not be detected. Thus, it may not be possible to accurately determine a trend of defects on the entire substrate.

### SUMMARY

Embodiments provide a method of inspecting defects irregularly distributed on a substrate.

In accordance with an embodiment, a method of inspecting a defect on an object includes dividing the object into a plurality of inspection regions. A plurality of levels is determined according to the numbers of defects, which are expected before detecting the defects, on the inspection regions. The defects on a selected inspection region are detected. The level including a range, which corresponds to the number of defects detected on the selected inspection region, is assigned to the selected inspection region with reference to the number of defects detected on the selected inspection region. The defect detection step and the level assignment step are repeated with respect to remaining inspection regions.

The method may further comprise selecting some inspection regions from among the inspection regions, to which the levels are assigned, as samples, and storing defect images of the samples.

The method may further comprise determining whether the levels assigned to the inspection regions are concentrated to a certain level or not, and again performing the steps of setting levels, detecting defects, and assigning the levels on the basis of the certain level, when the levels assigned to the inspection regions are concentrated to the certain level.

In accordance with another embodiment, a method of inspecting defect on an object is provided. In the method, the object is divided into a plurality of inspection regions. The defects on a selected inspection region are detected. The number of defects detected from the selected inspection region is stored. The steps of detecting defects and storing the number of the defects are repeated with respect to remaining inspection regions.

The method may further comprise setting a plurality of levels according to a distribution of the numbers of the defects detected from the inspection regions, and assigning the level including a range, which corresponds to the number of defects detected on the selected inspection region, to the selected inspection region with reference to the number of defects detected on the selected inspection region. In addition, the method may further comprise selecting some inspection regions from among the inspection regions to which the levels are assigned as samples, detecting the defects again with respect to the samples, and storing defect images of the samples obtained by detecting the defects.

According to embodiments, the levels of the inspection regions or the numbers of defects on the inspection regions may be stored regardless of the position and the image of the defects. Thus, although there may be a lot of defects on a substrate, all of the defects on the substrate may be inspected. As a result, the total number of defects on the entire substrate may be easily calculated.

### BRIEF DESCRIPTION OF THE DRAWINGS

The above and other advantages will become readily apparent by reference to the following detailed description when considered in conjunction with the accompanying drawings in which:

FIG. 1 is a block diagram illustrating an apparatus for inspecting a defect on a substrate according to aspects of the invention;

FIG. 2 is a flow chart illustrating methods of inspecting a defect on a substrate in accordance with the embodiment of FIG. 1;

FIGS. 3 to 7 are diagrams illustrating a schematic carrying out of the methods in FIG. 2;

FIG. 8 is a block diagram illustrating an apparatus for detecting a defect on a substrate in accordance with another aspect of the invention; and

FIG. 9 is a flow chart illustrating methods of inspecting a defect on a substrate in accordance with the embodiment shown in FIG. 8.

### DESCRIPTION OF THE EMBODIMENTS

Embodiments of the present invention will be described with reference to the accompanying drawings. The present invention may, however, be embodied in many different forms and should not be construed as limited to the embodiments set forth herein. Rather, the embodiments are provided so that disclosure of the present invention will be thorough and complete, and will fully convey the scope of the present invention to those skilled in the art. The principles and features of this invention may be employed in varied and numerous embodiments without departing from the scope of the present invention. In the drawings, the size and relative sizes of layers and regions may be exaggerated for clarity. The drawings are not to scale. Like reference numerals designate like elements throughout the drawings.

It will also be understood that when an element or layer is referred to as being “on” another element or layer, the element or layer may be directly on the other element or layer or intervening elements or layers may be present. As used herein, the term “and/or” may include any and all combinations of one or more of the associated listed items.

It will also be understood that, although the terms first, second, etc. may be used herein to describe various elements, components, regions and/or sections. These elements, components, regions and/or sections should not be limited by these terms. These terms may be used to distinguish one element, component, region and/or section from another element, component, region and/or section. For example, a first element, component, region and/or section discussed below could be termed a second element, component, region and/or section without departing from the teachings of the present invention.

The terminology used herein is for the purpose of describing particular embodiments only and is not intended to limit of the invention. As used herein, the singular terms “a,” “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof.

Unless otherwise defined, all terms (including technical and scientific terms) used herein may have the same meaning as what is commonly understood by one of ordinary skill in the art. It will be further understood that terms, such as those defined in commonly used dictionaries, should be interpreted as having a meaning that is consistent with their meaning in the context of the relevant art and will not be interpreted in an idealized and/or overly formal sense unless expressly so defined herein.

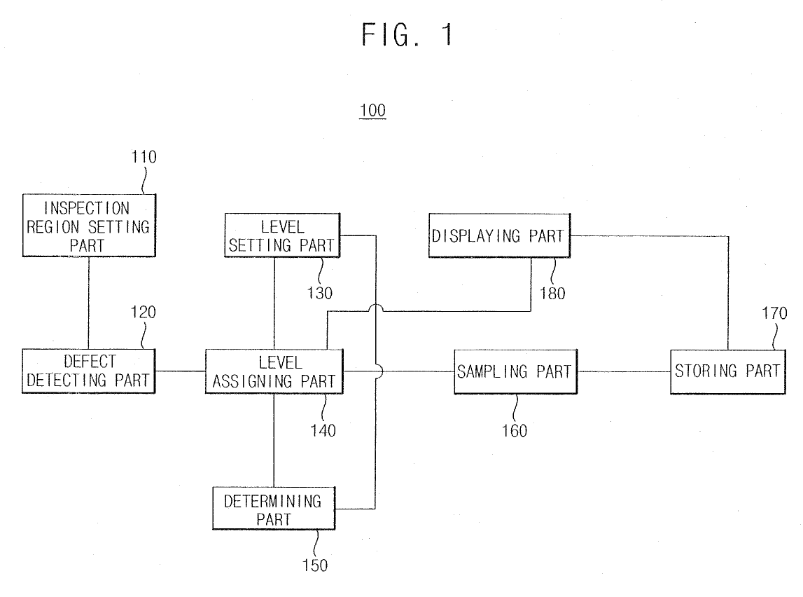

FIG. 1 is a block diagram illustrating an apparatus for inspecting a defect on a substrate, according to an embodiment.

Referring to FIG. 1, an apparatus 100 includes an inspection region setting part 110, a defect detecting part 120, a level setting part 130, a level assigning part 140, a determining part 150, a sampling part 160, a storing part 170, and a displaying part 180.

The inspection region setting part 110 divides a surface of a substrate into a plurality of inspection regions. The inspection regions may have substantially the same sizes. For example, the inspection region may correspond to a die formed on the substrate.

The defect detecting part 120 detects defects on the substrate. In addition, the defect detecting part 120 may count the number of the defects. The defect detecting part 120 may detect the defects from each of the inspection regions. Thus, the number of the defects may be counted from each of the inspection regions.

The defect detecting part 120 may include a laser beam and a laser beam detector. The laser beam irradiates a laser beam onto the substrate. The laser beam detector detects a scattered laser beam and a reflected laser beam from the substrate. As one alternative, the defect detecting part 120 includes a lamp for illuminating the substrate and a charge-coupled device (CCD) for detecting an image of the substrate. As another alternative, the defect detecting part 120 includes an electron beam generator for emitting an electron beam onto the substrate and an electron detector for detecting secondary electrons emitted from the substrate. The defect detecting part 120 detects the defects on the substrate by using the laser detector, the electron detector, or the CCD, to list some examples, The defect detecting part 120 may then count the number of the defects.

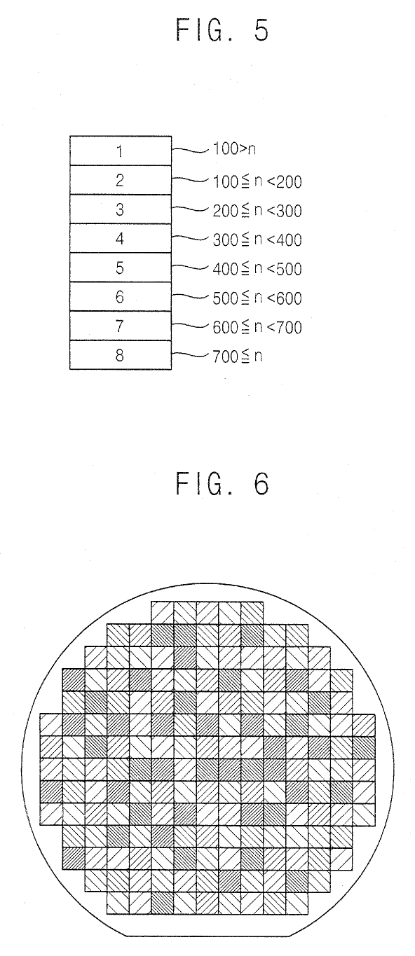

The level setting part 130 sets a plurality of levels including ranges corresponding to the numbers of defects that are to be counted from each of the inspection regions. Various variations of the number of the levels are possible. Ranges of the levels are substantially the same in size. In its simplest iteration, level setting part 130 determines the highest defect number detected from a single one of the regions of the substrate and creates a plurality of equivalent ranges from zero to that highest number. The number of levels set is intended to allow one to visually distinguish a color, pattern, or other indicia assigned to one level from another. Ten levels or less are preferred with eight different levels being most preferred as shown in FIGS. 4 and 5. If the highest defect count of any region is 2000 particles, then each level range would include the number of levels divided by this amount. As appreciated from the discussion further below, this even distribution of levels may be reassigned if the result is an unmeaningful clustering of indicia (e.g., all but a few regions are within the same level). Such an unmeaningful clustering is detected in determining part 150, described below, and referred to herein as an example of a maldistribution of levels.

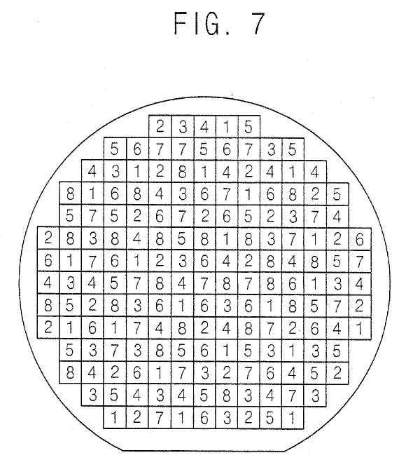

The level assigning part 140 assigns the levels set by the level setting part 130 to each of the inspection regions by considering the numbers of the defects detected from each of the inspection regions. Here, the numbers of the defects may be counted by the defect detecting part 120. This is shown visually by, for example, assigning a visual pattern (FIG. 6) or number (FIG. 7) to the region in the projected image of the substrate and displaying the resulting image for view using displaying part 180.

The determining part 150 determines whether a maldistribution of the levels assigned to the inspection regions by the level assigning part 140 occurs or not. The level assigned to an inspection region may vary with the number of defects in the inspection region. Thus, in case the numbers of defects in the inspection regions are not uniform, the levels may be varied. On the other hand, in case the numbers of the defects in the inspection regions are substantially the same, a specific level may be assigned to the inspection regions. That is, the maldistribution of the levels may occur. The determining part 150 determines whether the maldistribution of the levels occurs or not. In case the maldistribution of the levels occurs, it is difficult to obtain a trend of the defects on the entire substrate. Thus, it is important to determine whether the maldistribution of the levels exists or not.

The sampling part 160 selects samples from the inspection regions to which the levels are assigned. As one example, the number of samples selected corresponding to a certain level may be substantially proportional to the number of inspection regions having the certain level. As another example, the sampling part 160 selects substantially the same number of samples from each level.

The storing part 170 stores defect images of the inspection regions selected as samples from each level.

The displaying part 180 may display the levels of the inspection regions on a map of the substrate. The levels of the inspection regions may be indicated on the map of the substrate by using different numbers, different colors or different patterns. Thus, a trend of the defects on the entire substrate may be effectively indicated. In addition, the display part 180 may display the defects images of the inspections regions stored in the storing part 170.

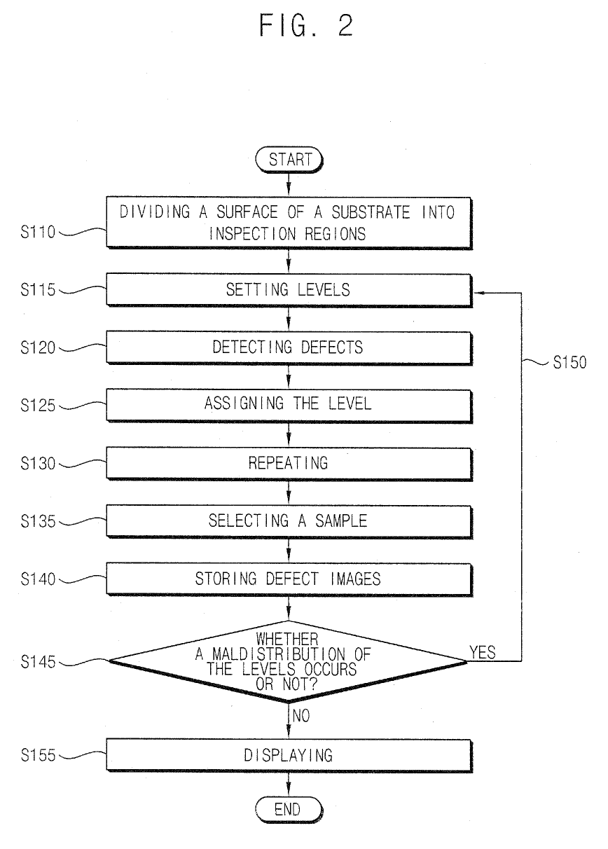

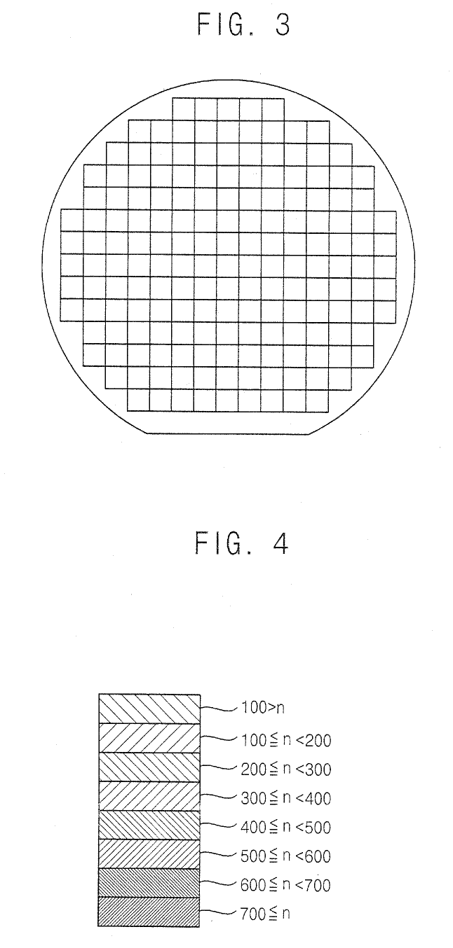

FIG. 2 is a flow chart illustrating a method of inspecting a defect on a substrate in accordance with an embodiment. FIGS. 3 to 7 are diagrams illustrating the method in FIG. 2.

Hereinafter, the method of inspecting a defect on the substrate will be described with reference to FIGS. 2 to 7.

Referring to FIG. 2, a surface of the substrate is divided into a plurality of inspection regions in step S110.

It is difficult to inspect the entire surface of the substrate at a time. Thus, the surface of the substrate is initially divided into the inspection regions. Each inspection region is then inspected so that the entire surface of the substrate may be done so efficiently. As a result, the inspection region setting part 110 may divide the surface of the substrate into the inspection regions. The inspection regions may have substantially the same sizes. As illustrated in FIG. 3, the inspection region may conveniently correspond to a die. That is, the inspection region may correspond to a chip of the substrate, each shown by one of the plurality of boxes within the substrate wafer of FIG. 3.

Next, in step S115, a plurality of levels are set, having fixed ranges, for the numbers of defects that are still to be detected.

Particularly, a level setting part 130 establishes, for a first iteration, a range of the number of defects that will probably be detected in one inspection region. That is, the level setting part 130 attempts to predict the maximum number of defects and the minimum number of defects that are to be detected at one inspection region. The maximum number of defects and the minimum number of defects may be inferred from a previous inspection result concerning the number of defects on an inspection region of a substrate. Subsequently, the number of levels into which the range is divided may be determined. The number of levels, i.e., a resolution, may vary in accordance with a level of inspection accuracy. If the inspection accuracy is relatively high, the number of levels may be relatively large, corresponding to a high resolution. On the other hand, if the inspection accuracy is relatively low, the number of levels may be relatively small, corresponding to a low resolution. Here, the levels may have substantially the same ranges except for the levels that include ranges that correspond to the number of defects smaller than the minimum number or the number of defects larger than the maximum number.

For example, as illustrated in FIG. 4 or FIG. 5, if the number of defects that is to be detected at one inspection region is about 100 to about 700, the minimum number of defects and the maximum number of defects may be set at about 100 and about 700, respectively. The number of levels, corresponding to the detection resolution, may be set at about 8. In this case, a level including a range, which corresponds to the number of defects, as well as the range of the level, may be automatically determined. That is, if the number of defects is smaller than about 100, level 1 is assigned. If the number of defects is no less than about 100 and fewer than about 200, level 2 is assigned. If the number of defects is no less than about 200 and fewer than about 300, level 3 is assigned. If the number of defects is no less than about 300 and fewer than about 400, level 4 is assigned. If the number of defects is no less than about 400 and fewer than about 500, level 5 is assigned. If the number of defects is no less than about 500 and fewer than about 600, level 6 is assigned. If the number of defects is no less than about 600 and fewer than about 700, level 7 is assigned. If the number of defects is no less than about 700, level 8 is assigned. Level 2 to level 7, but excluding level 1 and level 8, may have substantially the same sizes.

In this case, the levels may be distinguished from one another by using patterns in a display, as illustrated in FIG. 4. As one alternative, the levels may be distinguished from one another by using numbers as illustrated in FIG. 5. As another alternative, the levels may be distinguished from one another by using colors, levels of brightness, etc.

As described above, a level including a range, which corresponds to the number of defects, may be determined after the inspection region of the substrate is determined. However, the inspection region of the substrate may be determined after the level of the number of defects is determined. Alternatively, the level including a range, which corresponds to the number of defects, and the inspection region of the substrate may be determined at substantially the same time.

After the level including a range, which corresponds to the number of defects, and the inspection region of the substrate are determined, a detection of defects is performed on a selected inspection region in step S120.

Particularly, defects are detected from the selected inspection region by using the defect detecting part 120. In addition, the number of defects may also be counted using the defect detecting part 120.

As one example, the defects may be detected using a laser and a detector. A laser beam generated from the laser may scan the selected inspection region. The detector may detect scattered light from the selected inspection region or specularly reflected light from the selected inspection region.

As another example, the defects may be detected using a lamp and a CCD. A light generated from the lamp may illuminate the selected inspection region. Thereafter, the CCD may pick up an image of the selected inspection region.

As still another example, the detects may be detected using an electron beam generator and a detector. An electron beam generated from the electron beam generator may scan the selected inspection region. Thereafter, the detector may detect secondary electrons emitted from the selected inspection region.

The defect detecting part 120 may compare information obtained from the scattered light, the reflected light, an image picked up by the CCD or the secondary electrons to predetermined information, to detect the defects of the selected inspection region. That is, if the obtained information is within an error limit of the predetermined information, it is determined that there is no defect. However, if the obtained information exceeds the error limit of the predetermined information, it is determined that there is a defect. The number of defects may be counted using a position and an image of the defect detected on the selected inspection region.

Thereafter, a level including a range, which corresponds to the number of defects, is assigned to the selected region by comparing the number of defects detected from the selected inspection region to the levels in step S125.

Particularly, the level assigning part 140 may compare the number of defects detected from the selected inspection region to the number of defects that is assigned to respective levels. Thereafter, the level assigning part 140 may select the level including a range, which corresponds to the number of defects detected on the selected inspection region.

A step of detecting defects and a step of assigning levels may be repeatedly performed on the remaining inspection regions in step S130.

After completing the steps of detecting defects and the step of assigning levels with respect to the selected inspection region, the step of detecting defects and the step of assigning levels are performed with respect to another inspection region by using the defect detecting part 120 and the level assigning part 140. As described above, the step of detecting defects and the step of assigning levels may be performed sequentially. The step of detecting defects and the step of assigning levels may continue until a detection of the defect and an assignment of the level with respect to the entire inspection regions are completed.

Here, the position and the image of the defect may be used in a succeeding sampling step. If the position and the image of the defect are not used in the sampling step, the position and the image of the defect may be deleted.

As described above, the levels of the inspection regions are set and then stored regardless of the position and the image of the defects. Because only the number of defects, and not their type and exact position within the substrate, are stored, the amount of data to be stored is severely reduced. Thus, an overflow of data may be prevented. As a result, an interruption of the inspection due to the overflow may also be prevented.

In addition, the inspection regions of the entire substrate may be efficiently inspected. Thus, it is possible to determine which portion of the substrate has relatively many defects and which portion of the substrate has relatively few defects. That is, a trend of defects on the substrate may be easily obtained and observed. Also, a total number of the defects detected from the substrate may be estimated by multiplying the average of the numbers of defects by the number of inspection regions having a certain level.

Next, some inspection regions to which the levels are assigned are selected as samples in step S135.

The number of samples selected from a predetermined level may be substantially proportional to the number of inspection regions corresponding to each level. Alternatively, the number of samples selected from the respective levels may be substantially the same. That is, a sampling part 160 may select a certain percentage of the inspection regions having a predetermined level as samples of the predetermined level. Alternatively, substantially the same number of inspection regions may be selected as samples from the respective levels regardless of the number of inspection regions corresponding to each level. The percentage or number of samples may vary in accordance with a kind or a frequency of the defects.

The sampling may be performed simultaneously with the step of detecting defects and the step of assigning levels with respect to the inspection regions.

If the number of samples selected from a predetermined level is substantially proportional to the number of inspection regions corresponding to each level, images and positions of the defects are selected each time the number of levels exceeds a certain range, while the steps of detecting defects and assigning levels with respect to the inspection regions are sequentially performed.

If substantially the same number of inspection regions is selected as samples from the respective levels regardless of the number of inspection regions corresponding to each level, images and positions of the defects are selected from the beginning of the sampling until the number of samples reaches a predetermined value, while the steps of detecting defects and assigning levels with respect to the inspection regions are sequentially performed.

Selected images of the defects on the inspection regions may then be stored in step S140.

A storing part 170 may store images and positions of the defects of the inspection regions selected as samples by the sampling part 160.

In some embodiments, the inspection region selected as the sample by the sampling part 160 may be detected again by the defect detecting part. Images and positions of the defects obtained by repeated detection may be stored in the storing part 170.

After the detection of the inspection regions on the entire substrate and the assignment of levels are completed, whether the levels are distributed at a certain level or not is determined in step S145. That is, a maldistribution of levels is determined in step S145.

Particularly, after the levels are assigned to the inspection regions, the number of inspection regions assigned to each level is calculated. The determining part 150 may determine whether the number of inspection regions is overly concentrated at a certain level or not. That is, the determining part 150 may determine whether the number of inspection regions assigned to the certain level is larger than a predetermined standard. The predetermined standard may be expressed as a percentage of the number of inspection regions assigned to the certain level with respect to the total number of the inspection regions. The certain level may be one level. Alternatively, at least two levels that are adjacent to one another may be used together as the certain level. However, levels that are not adjacent to one another are preferably not to be used as the certain level.

For example, the predetermined standard may be 80%. If a percentage of the number of inspection regions assigned to level 4 with respect to the total number of the inspection regions is above 80%, defects may be concentrated to level 4. If the percentage of the number of inspection regions assigned to level 4 with respect to the total number of the inspection regions is less than 80%, the defects may not be concentrated to level 4.

As described above, if the percentage of the number of inspection regions assigned to level 4 with respect to the total number of the inspection regions is less than 80%, the defects may not be concentrated to level 4. However, if the percentage of the number of inspection regions assigned to level 4 and level 5 adjacent to level 4 with respect to the total number of the inspection regions is above 80%, the defects may be concentrated to level 4 and level 5.

If the number of levels assigned by the level setting part 130 is relatively large, three or four levels that are adjacent to one another may be used to determine whether the maldistribution occurs or not.

If the inspection regions are concentrated to a certain level, setting a level, the steps of detecting defects, and assigning levels may be performed again on the standard of the certain level in step S150.

If the inspection regions are concentrated to the certain level, it is difficult to obtain a trend of the defects on the entire substrate. Thus, the level setting part may redistribute and set levels again with reference to the certain level.

As an example of redistributing the levels, if the defects are concentrated to level 3 where the number of defects is above 300 and fewer than 400, one level may be set to an inspection region having less than 300 defects. Another level may be set to an inspection region having above 400 defects. In addition, level 3 may be divided into ten levels. As a result, twelve levels may be set again.

Thereafter, the defect detecting part 120 may detect defects with respect to one inspection region selected from among the inspection regions. The level assigning part 140 may assign a level again to the selected inspection region with reference to the number of defects detected by the defect detecting part 120. The steps of detecting defects and assigning levels may be performed on the remaining inspection regions.

Thus, levels assigned to the inspection regions may not be concentrated to a certain level. That is, a maldistribution of the level may not occur. Thus, a trend of defects on the entire substrate may be easily obtained.

Thereafter, a result of assigning the levels may be indicated on a map of the substrate in step S155.

As illustrated in FIG. 5, the displaying part 180 may indicate the result onto the map of the substrate after the levels are assigned to the inspection regions of the substrate.

That is, the levels are marked on each inspection region. As illustrated in FIG. 6, the levels may be marked using patterns. As one alternative, as illustrated in FIG. 7, the levels may be marked using numbers. As another alternative, although not particularly illustrated in the drawings, the levels may be marked using colors or levels of brightness.

A trend of defects on the substrate may be visually obtained using a result of assigning levels marked on the substrate map.

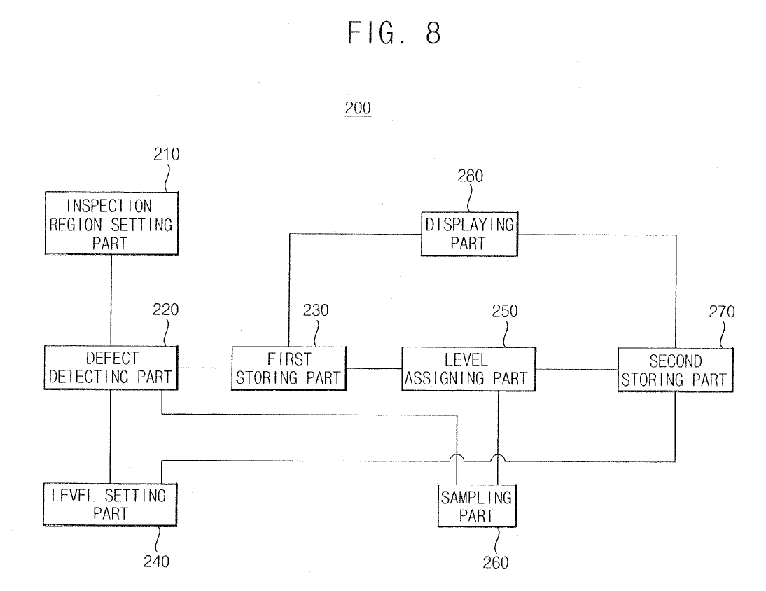

FIG. 8 is a block diagram illustrating an apparatus for detecting a defect on a substrate in accordance with another embodiment.

Referring to FIG. 8, an apparatus 200 for inspecting a defect on a substrate includes an inspection region setting part 210, a defect detecting part 220, a first storing part 230, a level setting part 240, a level assigning part 250, a sampling part 260, a second storing part 270, and a displaying part 280.

The inspection region setting part 210 is substantially the same as the inspection region setting part 110 of the apparatus 100 in FIG. 1.

The defect detecting part 220 is substantially the same as the defect detecting part 120 of the apparatus 100 in FIG. 1 except for detecting defects again from inspection regions selected by the sampling part 260.

The first storing part 230 may store the number of defects detected from the inspection regions by the defect detecting part 220. Thus, the first storing part 230 may store the total number of defects on the inspection regions.

The level setting part 240 may set a plurality of levels to the numbers of the defects with reference to the numbers of defects of the inspection regions stored in the first storing part 230. The number of levels may be determined with reference to a maximum number and a minimum number of defects of the inspection regions stored in the first storing part 230. The levels may be substantially the same in size and in range.

The level assigning part 250 assigns the levels to each of the inspection regions by using the number of the defects counted by the defect detecting part 220 and the levels set by the level setting part 240.

The sampling part 260 is substantially the same as the sampling part 160 of the apparatus 100 in FIG. 1. In addition, the second storing part 270 and the displaying part 280 may be substantially the same as the storing part 170 and the displaying part 180 of the apparatus 100 in FIG. 1, respectively.

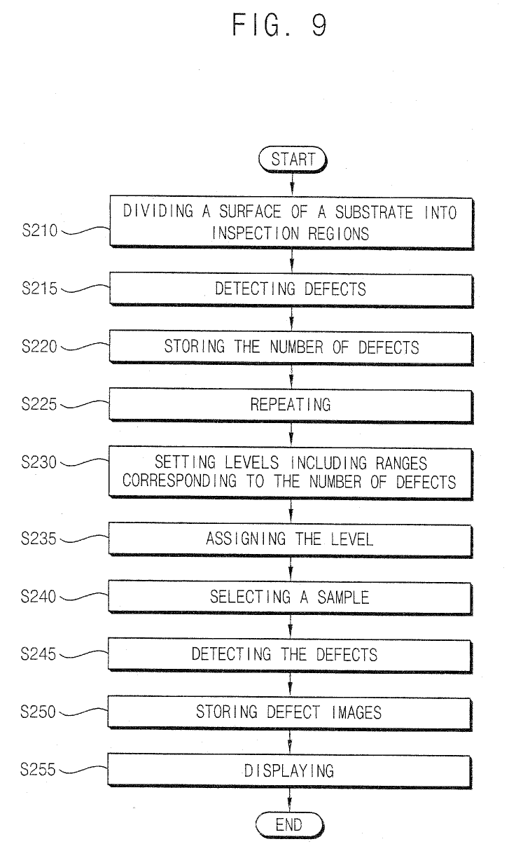

FIG. 9 is a flow chart illustrating a method of inspecting a defect on a substrate in accordance with another embodiment.

Referring to FIG. 9, a surface of the substrate is divided into a plurality of inspection regions in step S210.

It is difficult to inspect the entire surface of the substrate at a time. Thus, the surface of the substrate is initially divided into the inspection regions. Each inspection region is then inspected so that the entire surface of the substrate may be efficiently inspected. As a result, an inspection region setting part 210 may divide the surface of the substrate into the inspection regions. The inspection regions may have substantially the same sizes.

After the substrate is divided into the inspection regions, defects of a selected inspection region are detected in step S215.

Particularly, the defects are detected from the selected inspection region by using the defect detecting part 220. In addition, the number of defects is counted using the defect detecting part 220.

As one example, the defects may be inspected using a laser and a detector. As another example, an inspection for detecting defects may be performed using a lamp and a CCD. As still another example, an inspection for detecting defects may be performed using an electron beam generator and a detector. The defect detecting part 220 may compare obtained information to predetermined information, to detect the defects of the selected inspection region. That is, if the obtained information is within an error limit of the predetermined information, it is determined that there is no defect. However, if the obtained information exceeds the error limit of the predetermined information, it is determined that there is a defect. The number of defects may be obtained along with a detected position and image of each defect in the selected inspection region.

After the number of defects is obtained in detecting the defects, the position and the image of the defect obtained by the defect detecting part 220 may be deleted in order to prevent an overflow of data.

Thereafter, the number of defects on the selected inspection region obtained by detecting the defects may be stored in step S220.

Particularly, the number of defects on the selected inspection region may be stored in the first storing part 230.

The steps of detecting defects and storing the number of defects are repeatedly performed with respect to the remaining inspection regions in step S225.

After the detection of the defects and the storage of the number of defects with respect to the selected inspection region are completed, defects of an adjacent inspection region are detected and the number of the defects on the adjacent inspection region is stored. As described above, the steps of detecting defects and storing the number of the defects may be subsequently performed. The steps of detecting defects and storing the number of the defects may be performed on all of the inspection regions.

As described above, the levels of the inspection regions are set and then stored regardless of the position and the image of the defects. Thus, an overflow of data may be prevented. As a result, an interruption of the inspection due to the overflow may be prevented.

Thereafter, a plurality of levels is set to the numbers of defects with reference to a distribution of the numbers of defects on the inspection regions in step S230.

Particularly, the level setting part 240 determines a range of the number of defects with reference to the number of defects on the respective inspection regions stored in the first storing part 230 and a distribution of the number of defects. Thereafter, the number of levels, into which the range of the number of defects is divided, is determined. The number of levels may vary in accordance with a level of inspection accuracy. If the inspection accuracy is relatively high, the number of levels may be relatively large, corresponding to a high resolution. On the other hand, if the inspection accuracy is relatively low, the number of levels may be relatively small, corresponding to a low resolution. Here, the levels may have substantially the same ranges. However, a range of a level indicating the number of defects smaller than the minimum number or the number of defects larger than the maximum number may be different from those of remaining levels, as explained above for the previously-described embodiment.

As described above, a suitable number of defects may be determined, to efficiently indicate the numbers of defects on the inspection regions and a distribution of the numbers of defects on the inspection regions.

The levels may be marked on the inspection regions by using numbers. As one alternative, the levels may be marked using color. As another alternative, the levels may be marked using different levels of brightness.

Thereafter, a level is assigned to the inspection region with reference to the number of defects on the inspection region in step S235.

Particularly, the level assigning part 250 may compare the number of defects on the inspection regions stored in the first storing part 230 to the number of defects of the levels. Thereafter, the level assigning part 250 may assign the level to the inspection region with reference to the number of defects on the inspection regions stored in the first storing part 230 to the number of defects of the levels.

Thereafter, some inspection regions assigned the levels are selected as samples in step S240.

The number of samples selected from a predetermined level may be substantially proportional to the number of inspection regions corresponding to each level. Alternatively, the number of samples selected from the respective levels may be substantially the same. That is, a sampling part 160 may select a certain percentage of the inspection regions having a predetermined level as samples of the predetermined level. Alternatively, substantially the same number of inspection regions may be selected as samples from the respective levels regardless of the number of inspection regions corresponding to each level. The percentage or number of samples may vary in accordance with a kind or a frequency of the defects.

Thereafter, defects of the inspection regions that are selected as the samples are detected again in step S245.

As described above, the position and the image of the defect obtained by the defect detecting part 220 may be deleted in order to prevent an overflow of data after the number of defects is obtained by detecting the defects in step S215.

Thus, defects of the inspection regions selected as the samples may be detected again by the defect detecting part 220 in order to obtain positions and images of the defects on the inspection regions.

Images of the defects obtained by detecting the defects may be stored in step S250.

The second storing part 270 may store the positions and the images of the defects obtained by detecting the defects of the inspection regions selected as the sample.

Thereafter, a result of assigning the levels may be indicated onto a substrate map in step S255.

After the levels are assigned onto the inspection regions of the substrate, the displaying part 280 may display the result onto the substrate map. That is, the levels assigned to the inspection regions may be displayed. Each of the levels may be displayed using a pattern, a number, a color, a level of brightness, etc.

A trend of the defects may be visually obtained using the result of assigning the levels displayed onto the substrate map. Thus, it is possible to determine which portion of the substrate has relatively many defects and which portion of the substrate has relatively few defects. That is, a trend of defects on the entire substrate may be easily obtained.

According to the embodiments, the levels of the inspection regions or the numbers of defects on the inspection regions may be stored regardless of the position and the image of the defects. Thus, an overflow of data may be prevented. As a result, an interruption of the inspection due to the overflow may also be prevented. In addition, a trend of defects on the entire substrate may be easily obtained.

The foregoing is illustrative of the present invention and is not to be construed as limiting thereof. Although a few embodiments of this invention have been described, those skilled in the art will readily appreciate that many modifications are possible in the embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method of inspecting defects on an object, the method comprising:
dividing the object into a plurality of inspection regions;
establishing a plurality of levels, each level associated with a number range of defects;
detecting a number of defects on a selected inspection region;
repeating the step of detecting a number of defects with respect to remaining inspection regions; and
mapping information regarding the detected number of defects based on the established levels and ranges.

2. The method of claim 1, wherein the step of establishing the levels with ranges is performed before the defects on the inspection regions are detected.

3. The method of claim 2, wherein the step of establishing the levels with ranges is based on a previous inspection result of detected defects of another substrate.

4. The method of claim 1, wherein the step of establishing the levels with ranges is performed after the defects on the inspection regions are detected, and based on the results of the detected defects.

5. The method of claim 1, further comprising:
selecting some of the inspection regions to which the levels with ranges are assigned as samples; and
storing defect images of the samples.

6. The method of claim 5, wherein a number of samples selected from a certain level is substantially proportional to a number of inspection regions having the certain level.

7. The method of claim 5, wherein a number of samples selected from respective levels is substantially the same for each level.

8. The method of claim 1, further comprising:
determining whether the levels with ranges associated with the inspection regions are concentrated to a certain level or not; and
redistributing the levels with ranges among the inspection regions if the levels with ranges associated with the inspection regions are concentrated to the certain level.

9. The method of claim 1, further comprising displaying a result of assigning the levels with ranges onto a substrate map.

10. The method of claim 9, wherein the step of displaying includes assigning different visual indicia to each of the levels and displaying the visual indicia corresponding to the level.

11. A method of inspecting a defect on an object, the method comprising:
dividing the object into inspection regions;
detecting defects on a selected inspection region;
storing the number of defects detected on the selected inspection region; and
repeating the steps of detecting defects and storing the number of the defects with respect to remaining inspection regions.

12. The method of claim 11, further comprising:
setting levels according to a distribution of the number of the defects detected on the inspection regions; and
assigning the level including a range, which corresponds to the number of defects detected on the selected inspection region, to the selected inspection region with reference to the number of defects detected on the selected inspection region.

13. The method of claim 12, further comprising:
selecting some inspection regions from among the inspection regions to which the levels are assigned as samples;
detecting the defects again with respect to the samples; and
storing defect images of the samples obtained by detecting the defects again.

14. The method of claim 13, wherein a number of samples selected from a certain level may be substantially proportional to a number of inspection regions having the certain level.

15. The method of claim 13, wherein a number of samples selected from respective levels is substantially the same.

16. The method of claim 12, further comprising displaying a result of assigning the levels onto a substrate map.

17. The method of claim 16, wherein the result is displayed onto the substrate map by using different numbers, different colors, different patterns, or different levels of brightness.

18. The method of claim 10, wherein the visual indicia is taken from the list consisting of numbers, colors, patterns, and intensities.
